(19) United States
(12) Patent Application Publication
(10) Pub. No.: US 2018/0308481 A1
(43) Pub. Date: Oct. 25, 2018

(54) AUTOMATED ASSISTANT DATA FLOW

(71) Applicant: Semantic Machines, Inc., Newton, MA (US)

(72) Inventors: Jordan Cohen, Kure Beach, NC (US); Daniel Klein, Orinda, CA (US); David Leo Wright Hall, Berkeley, CA (US); Jason Wolfe, San Francisco, CA (US); Daniel Roth, Newton, MA (US)

(73) Assignee: Semantic Machines, Inc., Newton, MA (US)

(21) Appl. No.: 15/958,952

(22) Filed: Apr. 20, 2018

Related U.S. Application Data
(60) Provisional application No. 62/487,626, filed on Apr. 20, 2017.

(51) Int. Cl. G10L 15/22; G06N 3/00; G10L 15/18

(52) U.S. Cl. CPC G10L 15/22; G06N 3/006; G10L 13/043; G10L 2015/223; G10L 15/1815

(57) ABSTRACT

A system that transforms queries for each dialogue domain into constraint graphs, including both constraints explicitly provided by the user as well as implicit constraints that are inherent to the domain. Once all the domain-specific constraints have been collected into a graph, general-purpose domain-independent algorithms can be used to draw inferences for both intent disambiguation and constraint propagation. Given a candidate interpretation of a user utterance as the posting, modification, or retraction of a constraint, constraint inference techniques such as arc consistency and satisfiability checking can be used to answer questions. The underlying engine can also handle soft constraints, in cases where the constraint may be violated for some cost or in cases where there are different degrees of violations.

### CROSS REFERENCE TO RELATED APPLICATIONS

The present application claims the priority benefit of U.S. provisional patent application No. 62/487,626, filed on Apr. 20, 2017, titled “Automated Assistant Data Flow,” the disclosure of which is incorporated herein.

### BACKGROUND

An Automated Assistant is software which is designed to converse with a user about one or several domains of knowledge. Previous technology, like SIRI or Alexa, the command/control systems from Apple Computer and Amazon respectively, often fail to provide the system or answer which the user was looking for. For example, previous systems can handle basic requests for a narrow domain, but are typically inept at handling changes or more complicated tasks requested by a user. What is needed is an improved automated assistant I can respond to more complicated requests

### SUMMARY

Voice interfaces are now catching the attention of consumers the world over. Siri is available on Apple devices, Cortana is a Microsoft assistant, VIV offers a platform for developers which is like a chatbot, and Facebook offers support for chatbots of all kinds. These interfaces allow for limited conversational interactions between user and the applications.

In order to assure fluent conversational interactions, interactive interchanges require rapid planning for identifying constraints for the system, or for identifying situations where there are no solutions to the particular requirements. One method of providing rapid re-planning is by the use of constraint propagation or similar planning tools.

Constraint propagation is a method for pragmatic inference in dialogue flow based on inference in a constraint graph. Both a user's preferences as well as knowledge about real-world domain constraints are collected into a uniform constraint graph. Applying general-purpose satisfiability and constraint propagation algorithms to this graph then enables several kinds of pragmatic inference to improve dialogue flow:

To accomplish these inferences, the present technology transforms queries for each dialogue domain into constraint graphs, including both constraints explicitly provided by the user as well as implicit constraints that are inherent to the domain. Once all the domain-specific constraints have been collected into a graph, general-purpose domain-independent algorithms can be used to draw inferences for both intent disambiguation and constraint propagation. Given a candidate interpretation of a user utterance as the posting, modification, or retraction of a constraint, constraint inference techniques such as arc consistency and satisfiability checking can be used to answer questions. The underlying engine can also handle soft constraints, in cases where the constraint may be violated for some cost or in cases where there are different degrees of violations.

The combination of a state-dependent data-flow architecture combined with rapid constraint satisfaction computation can yield a very flexible computational engine capable of sophisticated problem solutions. Real time interactions are supported, as well as automatic re-computation of problem solutions during an interactive session.

In embodiments, a method for providing a conversational system. A first utterance is received by an application executing on a machine, the first utterance associated with a domain. A first constraint graph is generated by the application, based on the first utterance and one or more of a plurality of constraints associated with the domain. The application executes a first process based on the first constraint graph generated based on the first utterance the constraints associated with the domain. A second utterance is received by the application executing on the machine, the second utterance associated with the domain. A second constraint graph is generated based on the first constraint graph and the second utterance. The second constraint graph can be modified based on one or more of the plurality of constraints associated with the domain. The application executes a second process based on the modified second constraint graph.

### BRIEF DESCRIPTION OF FIGURES

FIG. 1 is a block diagram of a system for providing an automated assistant.

FIG. 2 is a block diagram of modules that implement an automated assistant application.

FIG. 3 is a block diagram of a detection mechanism module.

FIG. 4 is a method for handling data flow in an automated assistant.

FIG. 5 is a method for generating a constraint graph.

FIG. 6 is a method for updating a constraint graph.

FIG. 7 is a method for resolving constraint graph conflicts.

FIG. 8 is a method for processing soft restraints.

FIG. 9A illustrates an exemplary dialogue between a user and an agent.

FIG. 9B illustrates another exemplary dialogue between a user and an agent.

FIG. 9C illustrates another exemplary dialogue between a user and an agent.

FIG. 10 is a block diagram of a system for implementing the present technology.

### DETAILED DESCRIPTION

Fluent conversational interactions are very important in conversational interaction with automated assistant applications. Interactive interchanges with an automated assistant can require rapid planning for identifying constraints for the system, or for identifying situations where there are no solutions to the particular requirements. One method of providing rapid re-planning is by using constraint propagation or similar planning tools.

Constraint propagation is a method for pragmatic inference in dialogue flow based on inference in a constraint graph. Both a user's preferences as well as knowledge about real-world domain constraints are collected into a uniform constraint graph. Applying general-purpose satisfiability and constraint propagation algorithms to this graph then enables several kinds of pragmatic inference to improve dialogue flow.

To accomplish these inferences, the present technology transforms queries for each dialogue domain into constraint graphs, including both constraints explicitly provided by the user as well as implicit constraints that are inherent to the domain. Once all the domain-specific constraints have been collected into a graph, general-purpose domain-independent algorithms can be used to draw inferences for both intent disambiguation and constraint propagation. Given a candidate interpretation of a user utterance as the posting, modification, or retraction of a constraint, constraint inference techniques such as arc consistency and satisfiability checking can be used to answer questions. The underlying engine can also handle soft constraints, in cases where the constraint may be violated for some cost or in cases where there are different degrees of violations.

The combination of a state-dependent data-flow architecture combined with rapid constraint satisfaction computation can yield a very flexible computational engine capable of sophisticated problem solutions. Real time interactions are supported, as well as automatic re-computation of problem solutions during an interactive session.

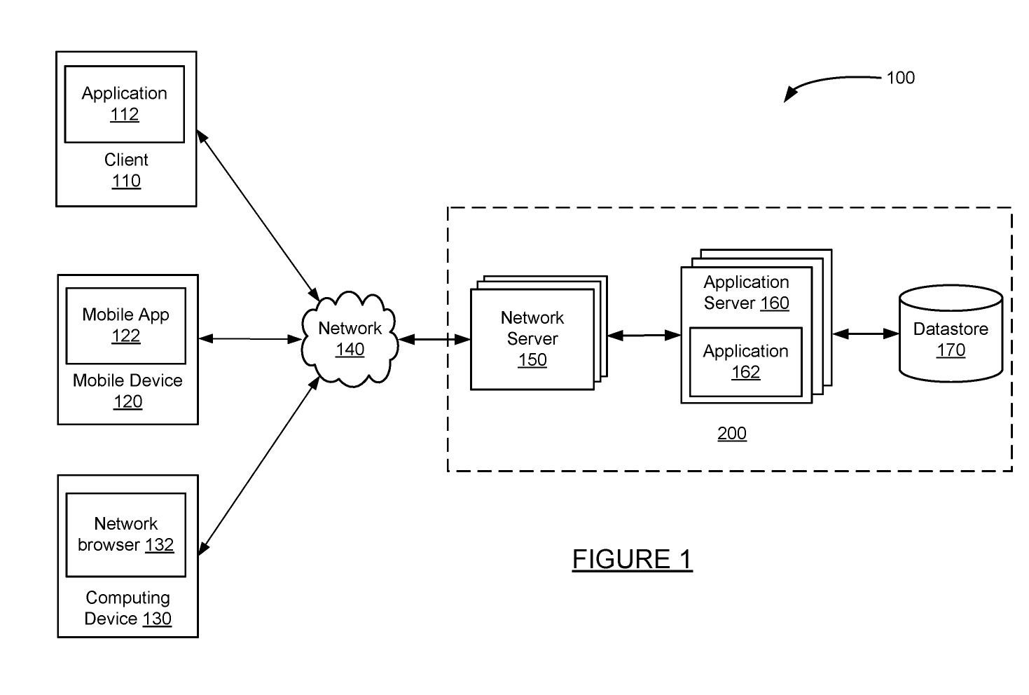

FIG. 1 is a block diagram of a system for providing an automated assistant. System 100 of FIG. 1 includes client 110, mobile device 120, computing device 130, network 140, network server 150, application server 160, and data store 170. Client 110, mobile device 120, and computing device 130 communicate with network server 150 over network 140. Network 140 may include a private network, public network, the Internet, and intranet, a WAN, a LAN, a cellular network, or some other network suitable for the transmission of data between computing devices of FIG. 1.

Client 110 includes application 112. Application 112 may provide an automated assistant, TTS functionality, automatic speech recognition, parsing, domain detection, and other functionality discussed herein. Application 112 may be implemented as one or more applications, objects, modules, or other software. Application 112 may communicate with application server 160 and data store 170 through the server architecture of FIG. 1 or directly (not illustrated in FIG. 1) to access data.

Mobile device 120 may include a mobile application 122. The mobile application may provide the same functionality described with respect to application 112. Mobile application 122 may be implemented as one or more applications, objects, modules, or other software, and may operate to provide services in conjunction with application server 160.

Computing device 130 may include a network browser 132. The network browser may receive one or more content pages, script code and other code that when loaded into the network browser the same functionality described with respect to application 112. The content pages may operate to provide services in conjunction with application server 160.

Network server 150 may receive requests and data from application 112, mobile application 122, and network browser 132 via network 140. The request may be initiated by the particular applications or browser applications. Network server 150 may process the request and data, transmit a response, or transmit the request and data or other content to application server 160.

Application server 160 includes application 162. The application server may receive data, including data requests received from applications 112 and 122 and browser 132, process the data, and transmit a response to network server 150. In some implementations, the network server 152 forwards responses to the computer or application that originally sent the request. Application's server 160 may also communicate with data store 170. For example, data can be accessed from data store 170 to be used by an application to provide the functionality described with respect to application 112. Application server 160 includes application 162, which may operate similar to application 112 except implemented all or in part on application server 160.

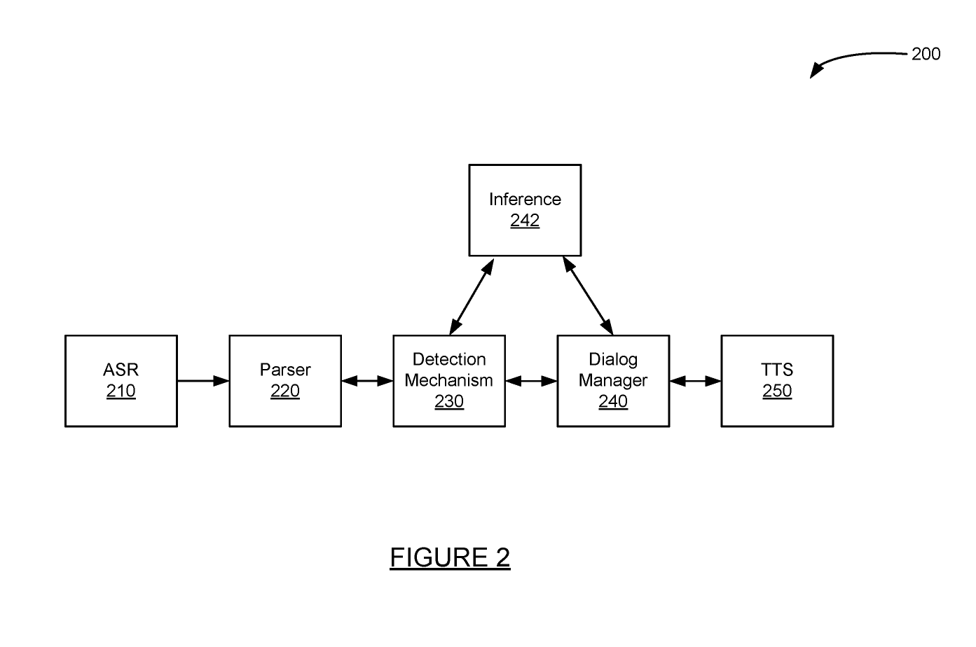

Block 200 includes network server 150, application server 160, and data store 170, and may be used to implement an automated assistant that includes a domain detection mechanism. Block 200 is discussed in more detail with respect to FIG. 2.

FIG. 2 is a block diagram of modules within automated assistant application. The modules comprising the automated assistant application may implement all or a portion of application 112 of client 110, mobile application 122 of mobile device 120, and/or application 162 and server 160 in the system of FIG. 1.

The automated assistant of the present technology includes a suite of programs which allows cooperative planning and execution of travel, or one of many more human-machine cooperative operations based on a conversational interface.

One way to implement the architecture for an attentive assistant is to use a data flow system for major elements of the design. In a standard data flow system, a computational element is described as having inputs and outputs, and the system asynchronously computes the output(s) whenever the inputs are available.

The data flow elements in the attentive assistant are similar to the traditional elements—for instance, if the user is asking for a round-trip airline ticket between two cities, the computing element for that ticket function has inputs for the date(s) of travel and the cities involved. Additionally, it has optional elements for the class of service, the number of stopovers, the maximum cost, the lengths of the flights, and the time of day for each flight.

When the computing unit receives the required inputs, it checks to see if optional elements have been received. It can initiate a conversation with the user to inquire about optional elements, and set them if the user requests. Finally, if all requirements for the flight are set, then the system looks up the appropriate flights, and picks the best one to display to the user. Then the system asks the user if it should book that flight.

If optional elements have not been specified but the required inputs are set, the system may prompt the user if he/she would like to set any of the optional elements, and if the user responds positively the system engages in a dialog which will elicit any optional requirements that the user wants to impose on the trip. Optional elements may be hard requirements (a particular date, for instance) or soft requirements (a preferred flight time or flight length). At the end of the optional element interchange, the system then looks up an appropriate flight, and displays it to the user. The system then asks the user whether it should book that flight.

The automated assistant application of FIG. 2 includes automatic speech recognition module 210, parser module 220, detection mechanism module 230, dialog manager module 240, inference module 242, and text to speech module 250. Automatic speech recognition module 210 receives an audio content, such as content received through a microphone from one of client 110, mobile device 120, or computing device 130, and may process the audio content to identify speech. The ASR module can output the recognized speech as a text utterance to parser 220.

Parser 220 receives the speech utterance, which includes one or more words, and can interpret a user utterance into intentions. Parser 220 may generate one or more plans, for example by creating one or more cards, using a current dialogue state received from elsewhere in the automated assistant. For example, parser 220, as a result of performing a parsing operation on the utterance, may generate one or more plans that may include performing one or more actions or tasks. In some instances, a plan may include generating one or more cards within a system. In another example, the action plan may include generating number of steps by system such as that described in U.S. patent application No. 62/462,736, filed Feb. 23, 2017, entitled “Expandable Dialogue System,” the disclosure of which is incorporated herein in its entirety.

In the conversational system of the present technology, a semantic parser is used to create information for the dialog manager. This semantic parser uses information about past usage as a primary source of information, combining the past use information with system actions and outputs, allowing each collection of words to be described by its contribution to the system actions. This results in creating a semantic description of the word/phrases.

The parser used in the present system should be capable of reporting words used in any utterance, and also should report used which could have been used (an analysis is available) but which were not used because they did not satisfy a threshold. In addition, an accounting of words not used will be helpful in later analysis of the interchanges by the machine learning system, where some of them may be converted to words or phrases in that particular context which have an assigned semantic label.

Detection mechanism 230 can receive the plan and coverage vector generated by parser 220, detect unparsed words that are likely to be important in the utterance, and modify the plan based on important unparsed words. Detection mechanism 230 may include a classifier that classifies each unparsed word as important or not based on one or more features. For each important word, a determination is made as to whether a score for the important word achieves a threshold. In some instances, any word or phrase candidate which is not already parsed by the system is analyzed by reference to its past statistical occurrences, and the system then decides whether or not to pay attention to the phrases. If the score for the important unparsed word reaches the threshold, the modified plan may include generating a message that the important unparsed word or some action associated with the unparsed word cannot be handled or performed by the administrative assistant.

In some instances, the present technology can identify the single phrase maximizing a “phraseScore” function, or run a Semi-Markov dynamic program to search for the maximum assignment of phrases to the phraseScore function. If used, the Dynamic program will satisfy the following recurrence

score[j]=max(score[j−1],max_{i<j}(score(i)+phraseScore(i,j)*all(elegible[i:j]))

The phrase can be returned with the highest score that exceeds some threshold (set for desired sensitivity). In some instances, a phraseScore is any computable function of the dialog state and the input utterance. In some instances, the phraseScore is a machine learnable function, estimated with a Neural Network or other statistical model, having the following features:

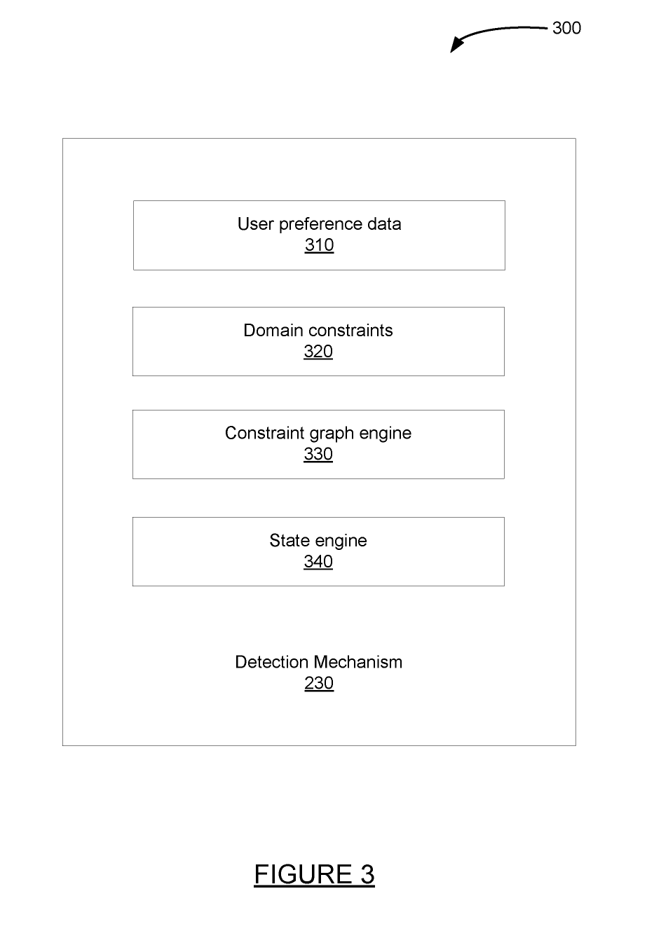

Detection mechanism 230 is discussed in more detail with respect to the block diagram of FIG. 3.

Dialog manager 240 may perform actions based on a plan and context received from detection mechanism 230 and/or parser 220 and generate a response based on the actions performed and any responses received, for example from external services and entities. The dialog manager's generated response may be output to text-to-speech module 250. Text-to-speech module 250 may receive the response, generate speech the received response, and output the speech to a device associated with a user.

Inference module 242 can be used to search databases and interact with users. The engine is augmented by per-domain-type sub-solvers and a constraint graph appropriate for the domain, and the general purpose engine uses a combination of its own inference mechanisms and the sub-solvers. The general purpose clearance engine could be a CSP solver or a weighted variant thereof. In this context, solvers include resolvers, constraints, preferences, or more classic domain-specific modules such as one that reasons about constraints on dates and times or numbers. Solvers respond with either results or with a message about the validity of certain constraints, or with information about which constraints must be supplied for it to function.

Additional details for an automated assistant application such as that of FIG. 2 are described in additional detail in U.S. patent application Ser. No. 15/792,236, filed Oct. 24, 2017, entitled “Sequence to Sequence Transformations for Speech Synthesis Via Recurrent Neural Networks,” the disclosure of which is incorporated herein in its entirety.

FIG. 3 is a block diagram of a detection mechanism. FIG. 3 provides more detail for detection mechanism 230 of FIG. 2. Detection mechanism 300 includes user preference data 310, domain constraints 320, constraint graph engine 330, and state engine 340. User preference data may include data received from a user in the current dialogue or previous dialogues, or in some other fashion, that specify preferences for performing tasks for the user. For example, in a present dialogue, the user preference data may include a home location, preferred class for traveling by airplane, preferred car rental company, and other data.

Domain constraints may include rules and logic specifying constraints that are particular to a domain. Examples include a constraint that an arrival time must occur after a departure time, a departure time must occur before an arrival time, a departure flight must occur before a return flight, and other constraints that may be particular to a domain.

A constraint graph engine includes logic for generating, modifying, adding to, and deleting constraints from a graph engine. The constraint graph engine 330 may create an initial constraint graph, modify the constraint graph based on explicit and implicit constraints, may modify a constraint graph based on subsequent user utterances, and may handle all or part of tasks related to retrieving needed information from a user to complete a task or the constraint graph itself.

State engine 340 may track the current state of the dialogue. The current state may reflect details provided by a user during the dialogue, tasks performed by the process, and other information.

The methods discussed below describe operations by the present application and system for modifying constraint graphs in response to information received from a user. For example, a user can change any of the inputs describing a flight, and the system will simply overwrite the old value with a new one. For instance, if the user has requested a flight from Boston to San Francisco, the user could say “No, I've changed my mind. I would like to leave from New York”, and the system would replace the slot containing Boston with one containing New York. In this case, the “re-planning” of the computation has minimal effect, simply refining the restrictions which the system will use for its plan.

When the system has identified a particular flight, but before that flight has been booked, the user may still change his mind about any of the inputs. For instance, changing the city from which the flights originate will cause the system to automatically re-compute new constraints for the flight search, and then it will automatically re-search the flights database and report the new flights to the user. This is typical data-flow activity; that is, when the inputs are changed, then the computational element re-computes the results.

However, in the Automated Assistant, the computational elements have “state” (in this case, a dialog state), which contains additional information about the conversation. The system can use this state information to change its actions with respect to modified inputs.

If a flight has not yet been booked, the system is free to initiate a new search, and can additionally start a dialog with the user to clarify/specify the characteristics of the search. For instance, if the original search had been on Friday morning, and the user changed his mind to leave on Saturday, the system might find that there were no Saturday morning flights. It would then inquire how the user would like to change the flight specification—leave Saturday afternoon or leave a different day—so that it could satisfy the user's request.

On the other hand, if the user has identified a flight, and has booked that flight, the Assistant no longer has control of the flight itself—it has been forwarded to a third party for booking, and maybe has been confirmed by the third party. In that case, changing the city of origin requires a much more complicated interaction. The system must confirm the cancellation with the user and then with the third party, and it may then find a new flight and book that in the normal way. Thus, the data-flow system works in broad brush, but in fact the action of the computing engine depends on the history of the user interchange in addition to the inputs to the particular module. This change in activities may be considered a “state” of the computing module—the actions of the module depend on the settings of the state.

Similar changes have to be made in the module which books rooms via a hotel website or lodging service—if a room has been booked and the user then changes his mind about a particular characteristic of his booking request, the discussion must then be modified to include cancelling the previous booking and then remaking a booking.

To assure fluent conversational interactions, interactive interchanges such as those described above require rapid planning for identifying constraints for the system, or for identifying situations where there are no solutions to the particular requirements. For instance, it should not be possible to book flights where the date of the initial leg is later than the returning leg, or where the cost of any leg exceeds a total cost requirement for a flight. The rapid computation of these constraints is necessary to enable real time interchange.

One method of providing rapid re-planning is by the use of constraint propagation or similar planning tools.

Constraint propagation is a method for pragmatic inference in dialogue flow based on inference in a constraint graph. Both a user's preferences as well as knowledge about real-world domain constraints are collected into a uniform constraint graph. Applying general-purpose satisfiability and constraint propagation algorithms to this graph then enables several kinds of pragmatic inference to improve dialogue flow:
1. Constraint propagation and invalidation. User says “I want to fly from SFO on January 1 and return January 5”, then asks “What if I leave January 7 instead?”. The system infers that it should not only change the outgoing departure date, but also remove the return date and re-prompt the user “When would you like to return?”.
2. Contextual constraint interpretation for intent disambiguation. System says “there is a round trip from SFO to Boston leaving at noon January 1 and arriving at 11 pm, and returning at 9 am on January 3 arriving at 11 pm”. If the user says “can you find something shorter than 20 hours”, the system infers that the user must be referring to total travel time, since both individual legs are shorter than 20 hours already. In contrast, if the user says “can you find something shorter than 6 hours”, the user must be referring to a specific leg of the journey (since 6 hours is inconsistent with the feasible range of total travel times).

To accomplish these inferences, the present technology can transform queries for each dialogue domain into constraint graphs, including both constraints explicitly provided by the user as well as implicit constraints that are inherent to the domain. For example, in the flight domain: explicit constraints include user preferences on outgoing and incoming departure and arrival times, as well as constraints on the duration of each leg; and implicit constraints include causal constraints (e.g., departure before arrival, and arrival before return) as well as definitional constraints (e.g., total travel time is outgoing travel time plus returning travel time). These features are discussed in more detail through discussion of the flowcharts below.

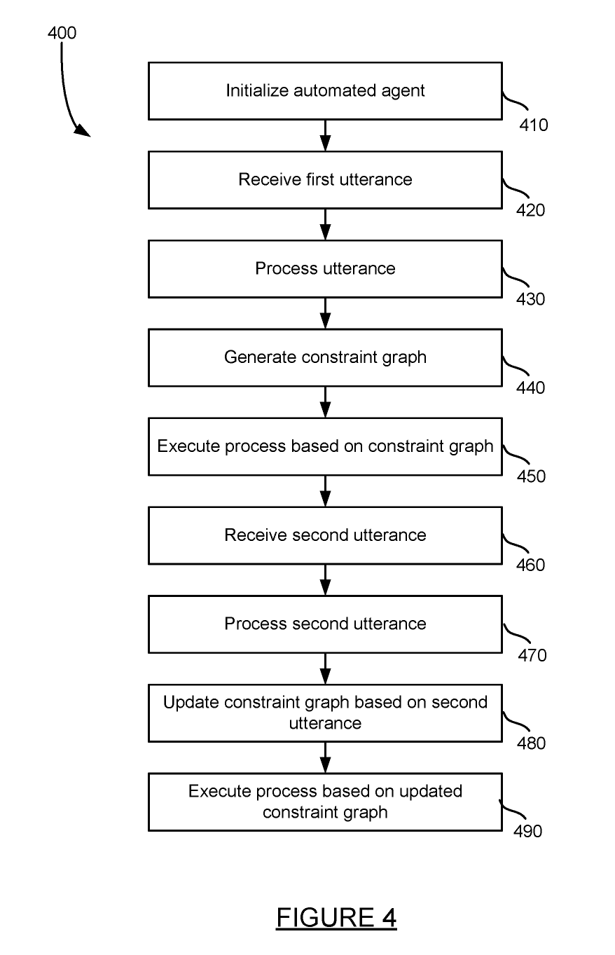

FIG. 4 is a method for handling data flow in an automated assistant. The method of FIG. 4 may be performed by the system of FIG. 1. First, an agent is initialized at step 410. Initializing the agent may include booting up the agent, providing access to domain data, and performing other initial operations to prepare the agent to interact with a user. A first utterance may be received by the automated agent at step 420. In some instances, the utterance is received from a user, either in spoken or text form, at a local or remote device with respect to a machine on which the automated agent is executing. The utterance is processed at step 430. Processing the utterance may include performing a speech to text operation, parsing the text of the utterance, and performing other operations to prepare utterance data to be processed by the present system.

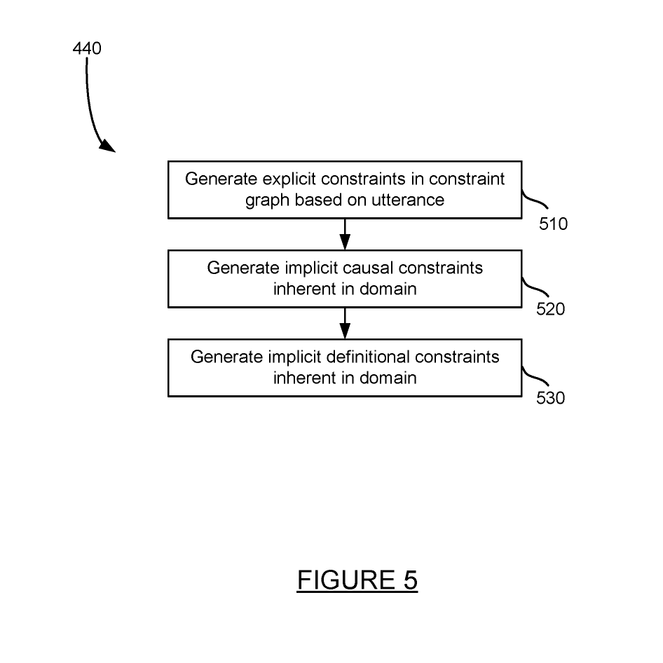

A constraint graph is generated at step 440. The constraint graph may include explicit and implicit constraints generated from the utterance and the domain. Constraints within the constraint graph help determine what tasks will be generated to perform a task requested by a user. Generating a constraint graph is discussed in more detail with respect to the method of FIG. 5.

A process is executed based on the constraint graph at step 450. Once the constraint graph is generated, or while the constraint graph is being generated, one or more processes may be executed. The processes will aim to satisfy a request by a user in the current dialogue. An initial root process, for example, may be designed to book a flight for a user. A sub process executed by the root process may include determining a departure city, determining an arrival city, determining the class of travel the user prefers, and so forth.

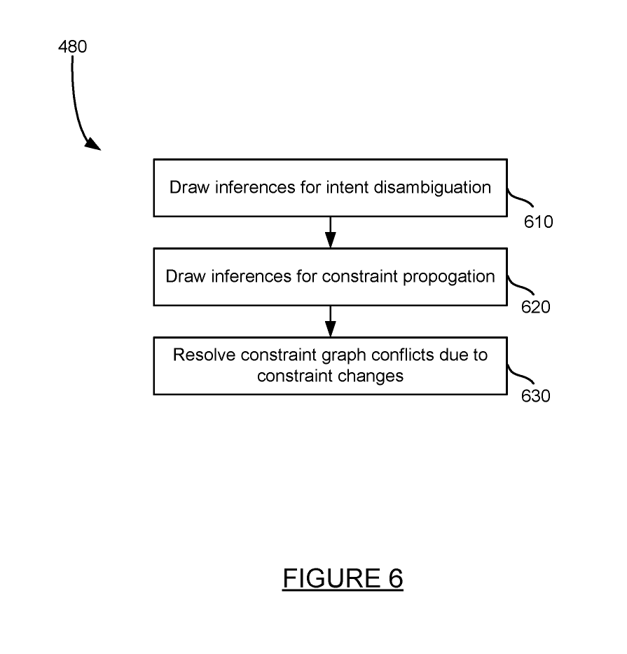

At some point during the method of FIG. 4, the automated agent may receive a second utterance from a user at step 460. The second utterance may cause a conflict in one or more constraints from the originally generated constraint graph produced at step 440. The second utterance is processed at step 470 (similar to the processing performed at step 430), and the constraint graph can be updated based on the second utterance at step 480. Updating the constraint graph is discussed in more detail in the method of FIG. 6.

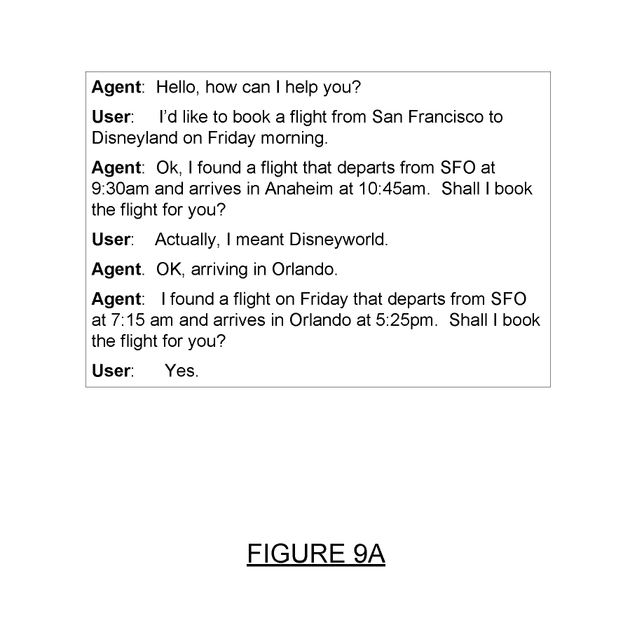

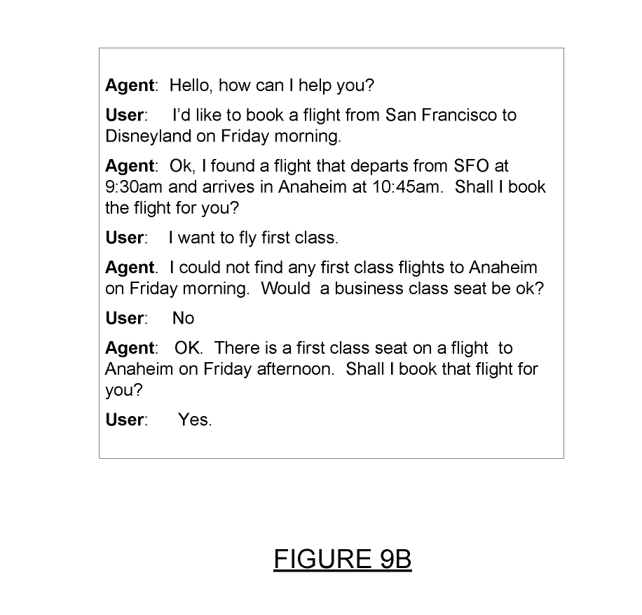

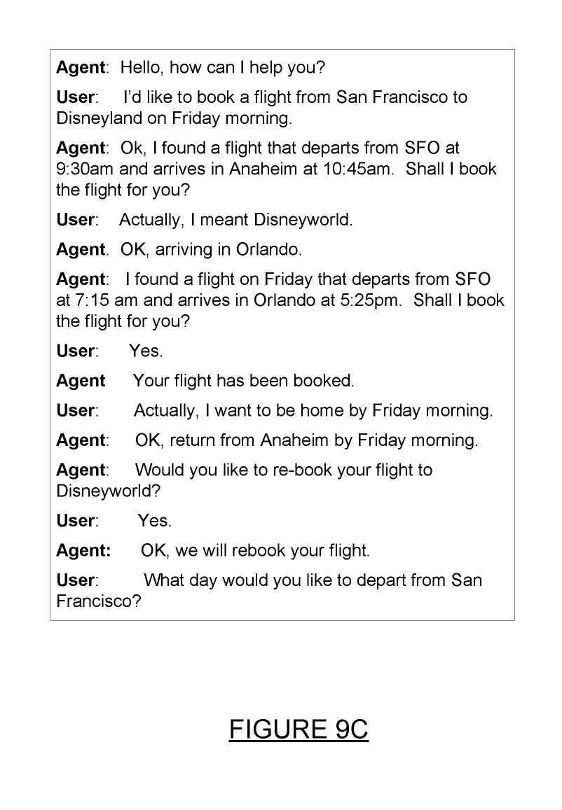

Upon updating the constraint graph, one or more processes are executed based on the updated constraint graph at step 490. The processes executed based on the updated constraint graph may include restarting one or more original processes performed at step 450, or indicating to a user that there are conflicts or tasks that are not able to be performed, in some cases unless more information is provided. In some instances, executing processes based on the updated constraint graph include performing revised tasks or new task for the user based on the second utterance and other constraints. Examples of dialogues where a process is executed based on updated constraint graphs is discussed with respect to FIGS. 9A-C.

FIG. 5 is a method for generating a constraint graph. The method of FIG. 5 provides more detail for step 440 the method of FIG. 4. First, explicit constraints are generated in a constraint graph based on the received utterance at step 510. The explicit constraints may include details provided by the user, such as in the domain of travel a constraint of a flight departure city, arrival city, day and time of flight, and other data. Implicit casual constraints inherent in the domain may be generated at step 520. A casual constraint may include a constraint that a departure must occur before an arrival, and an arrival must occur before a return. Implicit definitional constraints which are inherent in a domain may be generated at step 530. An example of a definitional constraint includes a total travel time defined as the outgoing travel time plus the return travel time. These generated constraints are collectively placed into the constraint graph for the current dialogue.

FIG. 6 is a method for updating a constraint graph. The method of FIG. 6 provides more detail for step 480 the method of FIG. 4. An inference can be drawn for intent disambiguation at step 610. An inference for constraint propagation can be drawn at step 620. Once all the domain-specific constraints have been collected into a graph, general-purpose domain-independent algorithms can be used to draw inferences for both intent disambiguation and constraint propagation. Given a candidate interpretation of a user utterance as the posting, modification, or retraction of a constraint, constraint inference techniques such as arc consistency and satisfiability checking can be used to answer questions such as:
Does this constraint change eliminate any possibilities consistent with the current graph? If not, it is a sign that this interpretation should be pragmatically dispreferred.
Does this constraint change make the graph unsatisfiable? If so, this is also a signal to pragmatically disprefer the interpretation. Moreover, if this interpretation is selected despite the conflict, general-purpose algorithms can be used to identify minimal-cost subsets of other constraints that can be removed to restore consistency. This minimal-cost alternative may be offered to the user to accept or modify.
A related situation arises when, e.g., the user has asked for a non-stop flight under $400 but none exists. Here the constraint graph itself appears a priori satisfiable, but all of the available flights violate one or more user constraints. The same inference algorithm as above can be used to suggest relaxing price or stop constraints to the user.

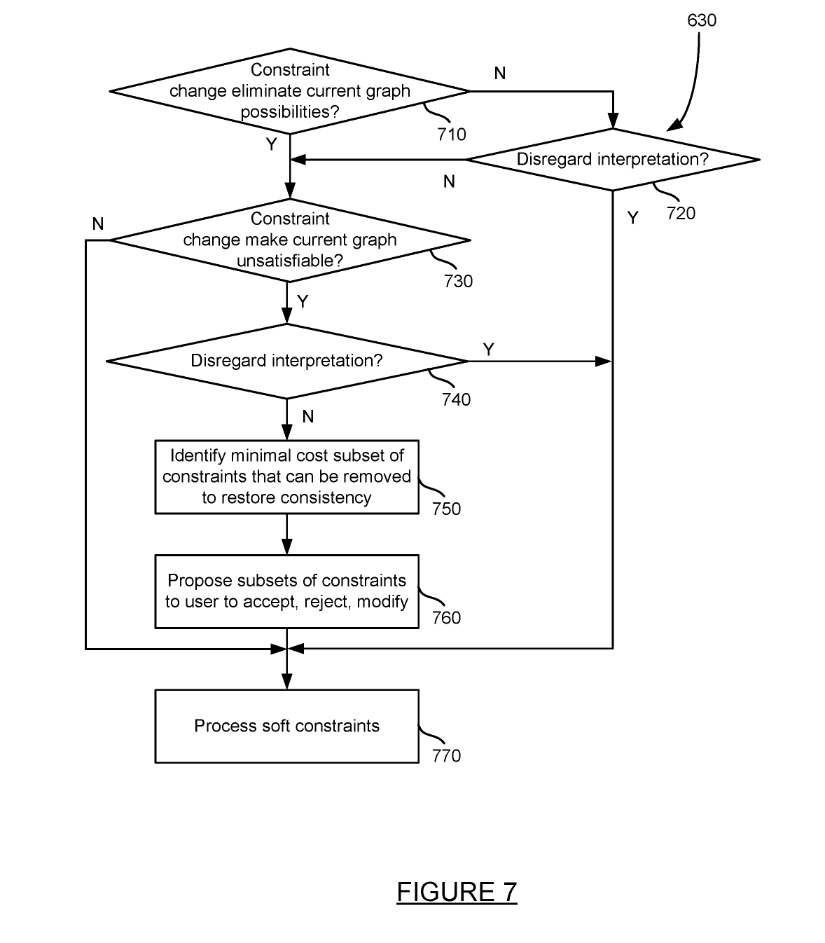

Returning to the method of FIG. 6, constraint graph conflicts are resolved due to constraint changes at step 630. Resolving the conflicts may include determining if a constraint change eliminates graph possibilities, makes a current graph unsatisfiable, and other determinations. Resolving constraint graph conflicts is discussed in more detail with respect to the method of FIG. 7

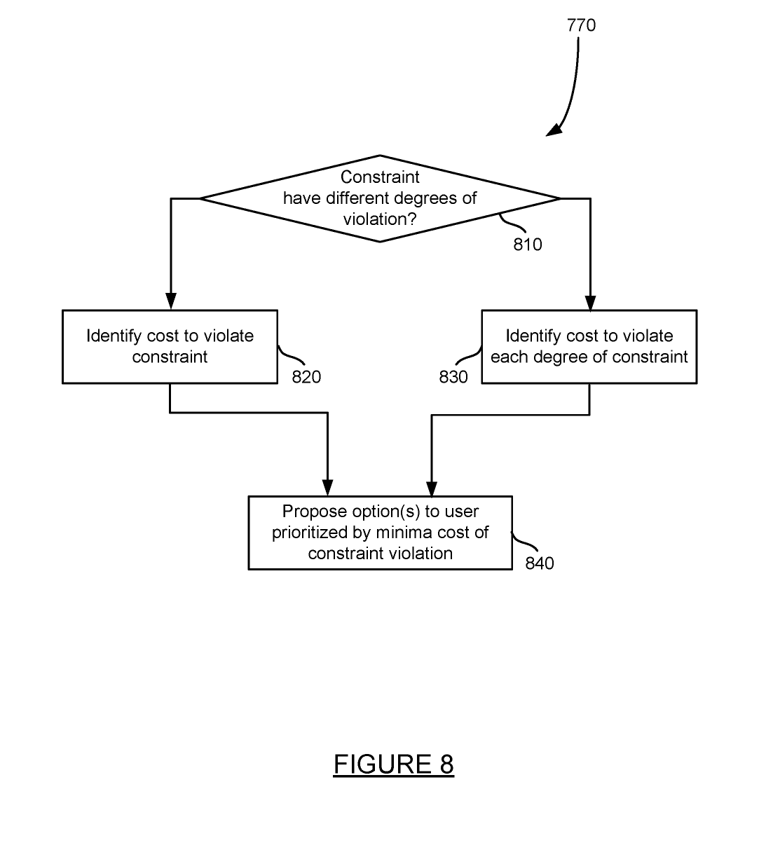

FIG. 7 is a method for resolving constraint graph conflicts. The method of FIG. 7 provides more detail for step 630 of the method of FIG. 3. First, a determination is made as to whether a constraint change eliminates current graph possibilities at step 710. If the change does not eliminate any current graph possibilities, it may be desirable to disregard interpretation that generated the particular constraint at step 720. If the interpretation is to be disregarded, the constraint is returned to its previous value, or removed if there was not previously incorporated into the constraint graph, and soft constraints can be processed at step 770. Processing of soft restraints is discussed in more detail with respect to FIG. 8.

A determination is made as to whether the current constraint provides a change that makes the current constraint graph unsatisfiable at step 730. If the constraint change makes the current graph unsatisfiable, a decision is made as to whether to disregard interpretation at step 740. If the constraint change does not make the graph unsatisfiable, the method of FIG. 7 continues to step 770. If, at step 740, a decision is made to disregard interpretation that led to generation or modification of the constraint, the method of FIG. 7 continues to step 770. If a decision is made to not disregard interpretation at step 740, the minimal cost subsets of constraints that can be removed to restore consistency is identified at step 750. Those identified subsets are then proposed to a user to accept, reject or modify at step 760. The method of FIG. 7 then continues to step 770.

FIG. 8 is a method for processing soft restraints. The method of FIG. 8 provides more detail of step 770 of the method of FIG. 7. First, a determination is made as to whether a constraint has different degrees of violation at step 810. If violation of the particular constraint can occur at different degrees or levels, the cost to violate each degree or level of the constraint is identified at step 830. If a constraint does not have different degrees of violation, the cost of violate the constraint is identified at step 820. After identifying violation costs at step 820 or 830, options can be proposed to user via generated utterances regarding the cost of the constraint violations at step 840. The options proposed may be prioritized by the minimal cost of the constraint violation. In some instances, an implementation of Markov Logic Networks (e.g. Alchemy) can be used to power the underlying inference mechanism for soft constraints.

FIG. 9A illustrates an exemplary dialogue between a user and an agent. The dialogue of FIG. 9 a is between an agent and a user would like to book a flight. In the dialogue, the user indicates that the flight should be booked from San Francisco to Disneyland on Friday morning. After the agent finds a flight that satisfies those constraints, the user provides a second utterance indicating that the user wants to fly to Disney World rather than Disneyland. The agent then determines that Disney World is a replacement for Disneyland, determines the arrival city as Orlando, and generates an utterance as “OK, arriving in Orlando.” The agent then generates another utterance indicating that a flight was found on Friday that satisfies the users constraints to fly from San Francisco to Orlando.

FIG. 9B illustrates another exemplary dialogue between a user and an agent. In the dialogue of FIG. 9B, the user again desires to fly from San Francisco to Disneyland, but then provides a second utterance indicating the user wants to fly first-class. The agent updates a constraint graph with the constraint of first-class, performs a new search for flights, and does not find any flight that matches the constraint graph. As a result, the agent determines a set of constraint violations that vary from the constraint graph including flights with a slightly lower class of seating and flights with a different departure time. The agent determines that the constraint violation having the minimal cost would be the flight with the different seating class, followed by a flight with a different departure time. Accordingly, the agent suggests the option of the different seating class with the utterance, “I could not find any first-class flights to Anaheim on Friday morning. Would a business class seat be okay?” The user responds with an utterance “No” to the first option, so the agent proposes the second option via the utterance “OK. There is a first-class seat on a flight to Anaheim on Friday afternoon. Can I book that flight for you?” The user then accepts the second option, and the automated agents may then book the flight.

FIG. 9C illustrates another exemplary dialogue between a user and an agent. In the dialogue of FIG. 9C, the user provides a first utterance indicating a request to fly from San Francisco to Disneyland, a second utterance indicating that the user meant to fly to Disney World, and then indicates a preference to be home by Friday morning after the flight has been booked. After the third utterance, the agent confirms that the user intends to return from Anaheim by Friday morning, recognizes that the booked flights cannot be redone, that rebooking process must be performed, and prompts the user accordingly. When the user accepts the option of rebooking the flight, the agent proceeds to obtain information from the user about rebooking the flight.

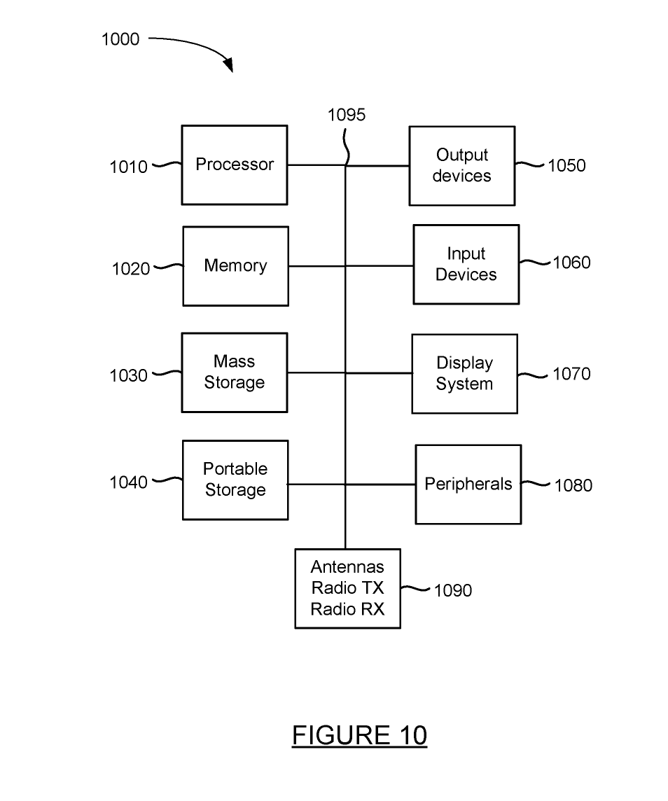

FIG. 10 is a block diagram of a system for implementing the present technology. System 1000 of FIG. 10 may be implemented in the contexts of the likes of client 110, mobile device 120, computing device 130, network server 150, application server 160, and data stores 170.

The computing system 1000 of FIG. 10 includes one or more processors 1010 and memory 1020. Main memory 1020 stores, in part, instructions and data for execution by processor 1010. Main memory 1010 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable or remote storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a compact disk, digital video disk, magnetic disk, flash storage, etc. to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), LED display, touch display, or other suitable display device. Display system 1070 receives textual and graphical information and processes the information for output to the display device. Display system may receive input through a touch display and transmit the received input for storage or further processing.

Peripherals 1080 may include any type of computer support device to add additional functionality to the computer system. For example, peripheral device(s) 1080 may include a modem or a router.

The components contained in the computer system 1000 of FIG. 10 can include a personal computer, hand held computing device, tablet computer, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Apple OS or iOS, Android, and other suitable operating systems, including mobile versions.

When implementing a mobile device such as smart phone or tablet computer, or any other computing device that communicates wirelessly, the computer system 1000 of FIG. 10 may include one or more antennas, radios, and other circuitry for communicating via wireless signals, such as for example communication using Wi-Fi, cellular, or other wireless signals.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for providing a conversational system, comprising:
receiving a first utterance by an application executing on a machine, the first utterance associated with a domain;
generating a first constraint graph, by the application, based on the first utterance and one or more of a plurality of constraints associated with the domain
executing, by the application, a first process based on the first constraint graph generated based on the first utterance the constraints associated with the domain;
receiving a second utterance by the application executing on the machine, the second utterance associated with the domain;
generating an second constraint graph based on the first constraint graph and the second utterance;
modifying the second constraint graph based on one or more of the plurality of constraints associated with the domain; and
executing, by the application, a second process based on the modified second constraint graph.

2. The method of claim 1, wherein modifying the second constraint graph includes resolving conflicts between conflicts between portions of the first constraint graph and constraints generated in response to the second utterance.

3. The method of claim 2, wherein resolving conflicts includes drawing inferences for intent disambiguation.

4. The method of claim 2, wherein resolving conflicts draw inferences for constraint propagation.

5. The method of claim 2, wherein resolving conflicts includes identifying whether changes to the first constraint graph made based on the second utterance eliminate possibilities consistent with first constraint graph.

6. The method of claim 2, wherein resolving conflicts includes identifying whether changes to the first constraint graph made based on the second utterance make the graph unsatisfiable.

7. The method of claim 1, wherein modifying the second constraint graph includes identifying a constraint within the constraint graph associated with a cost for violating the constraint.

8. The method of claim 7, wherein the constraint within the constraint graph associated with a cost for violating the constraint has a plurality of degrees of violation levels and costs.

9. The method of claim 8, further comprising generating a communication to propose a violation of the constraint prioritized by minimal cost.

10. The method of claim 1, wherein the utterance is received from a second machine remote from the machine that executes the application.

11. The method of claim 1, wherein the utterance is received directly from the user by the machine that executes the application.

12. A non-transitory computer readable storage medium having embodied thereon a program, the program being executable by a processor to perform a method for providing a conversational system, comprising:
receiving a first utterance by an application executing on a machine, the first utterance associated with a domain;
generating a first constraint graph, by the application, based on the first utterance and one or more of a plurality of constraints associated with the domain
executing, by the application, a first process based on the first constraint graph generated based on the first utterance the constraints associated with the domain;
receiving a second utterance by the application executing on the machine, the second utterance associated with the domain;
generating an second constraint graph based on the first constraint graph and the second utterance;
modifying the second constraint graph based on one or more of the plurality of constraints associated with the domain; and
executing, by the application, a second process based on the modified second constraint graph.

13. The non-transitory computer readable storage medium of claim 13, wherein modifying the second constraint graph includes resolving conflicts between conflicts between portions of the first constraint graph and constraints generated in response to the second utterance.

15. The non-transitory computer readable storage medium of claim 13, wherein resolving conflicts includes drawing inferences for intent disambiguation.

15. The non-transitory computer readable storage medium of claim 13, wherein resolving conflicts draw inferences for constraint propagation.

16. The non-transitory computer readable storage medium of claim 13, wherein resolving conflicts includes identifying whether changes to the first constraint graph made based on the second utterance eliminate possibilities consistent with first constraint graph.

17. The non-transitory computer readable storage medium of claim 13, wherein resolving conflicts includes identifying whether changes to the first constraint graph made based on the second utterance make the graph unsatisfiable.

18. The non-transitory computer readable storage medium of claim 12, wherein modifying the second constraint graph includes identifying a constraint within the constraint graph associated with a cost for violating the constraint.

19. The non-transitory computer readable storage medium of claim 18, wherein the constraint within the constraint graph associated with a cost for violating the constraint has a plurality of degrees of violation levels and costs.

20. The non-transitory computer readable storage medium of claim 19, further comprising generating a communication to propose a violation of the constraint prioritized by minimal cost.
